(19) United States
(12) Patent Application Publication
(10) Pub. No.: US 2024/0342863 A1
(43) Pub. Date: Oct. 17, 2024

(54) ROTATABLE GRINDING TOOL

(71) Applicant: BOLDAN OY, Rajamäki (FI)

(72) Inventor: Joni TUKIAINEN, Rajamäki (FI)

(21) Appl. No.: 18/637,467

(22) Filed: Apr. 17, 2024

(30) Foreign Application Priority Data
Apr. 17, 2023 (EP) 23168220.4

(51) Int. Cl. B24D 7/18; B24B 5/40

(52) U.S. Cl. CPC B24D 7/18; B24B 5/40

(57) ABSTRACT

A rotatable grinding tool (1) comprising a disc-like body (2) defining an intended direction of rotation (D), in which the grinding tool (1) is rotatable about a central axis (A) of the disc-like body (2), and a front side (3) intended to face a surface to be grinded, and a back side (4) opposite to the front side. The grinding tool (1) further comprises, on the front side (3) of the body (2), a plurality of teeth (5) each extending radially along said front side (3), wherein said teeth (5) being arranged spaced apart from each other. Particularly, the teeth (5) are formed integral with the body (2).

### FIELD OF THE DISCLOSURE

The present disclosure relates to tools for clearing pipes internally prior to lining, and more particularly to rotatable grinding tools of such kind.

### BACKGROUND OF THE DISCLOSURE

Pipe lining has become an increasingly popular method of renewing old pipes and ducts, such as sewer pipes. Pipe lining is typically carried out by introducing a liner impregnated with a suitable resin into the existing pipeline. The liner is then inflated so as to conform to the internal shape of the existing pipeline and the resin is then subsequently cured, thereby forming a new, solid inner surface within the existing pipeline. In order for the liner to adhere properly to the existing pipeline, the inner surface thereof must be thoroughly cleared from deposits, oxidation and other debris.

To this end, several types of tools are used for clearing the inside of the pipeline from debris and other obstacles. For example, disc-like rotatable tools with grinding teeth on the front side thereof have been used, wherein such tools are introduced through the existing pipeline using a wire or a cable. Simultaneously, the tool is rotated using a separate rotation actuator coupled to the tool with the same wire or cable used for introducing the tool.

Typically, such tools are manufactured by machining the disc-like body and providing the front surface with recesses into which separate abrasion resistant teeth are attached to. This increases the complexity and costs of manufacturing additional steps are required for producing and attaching the separate teeth, in addition to machining the associated recesses on the tool body itself. As the tool is subject to high wear, it has been conventionally considered a necessity to provide separate the teeth as separate components, as this enables them to be manufactured of a suitable wear resistant material other than the body itself.

### BRIEF DESCRIPTION OF THE DISCLOSURE

An object of the present disclosure is to provide a rotatable tool providing a simplified structure and manufacturing process while still providing sufficient wear-resistance properties.

The object of the disclosure is achieved by the rotatable tool which is characterized by what is stated in the independent claim. The preferred embodiments of the disclosure are disclosed in the dependent claims.

The disclosure is based on the idea of providing the teeth integral with the and the body, as a monolithic structure. It has surprisingly been found that sufficient wear resistance is achieved even without separate tooth inserts.

As a consequence, manufacture of the rotatable tool is simplified.

### BRIEF DESCRIPTION OF THE DRAWINGS

In the following the disclosure will be described in greater detail by means of preferred embodiments with reference to the accompanying drawings, in which

FIG. 1 illustrates a plan view of a rotatable grinding tool according the present disclosure, as seen as from a front side;

FIG. 2 illustrates a plan view of a rotatable grinding tool according the present disclosure, as seen as from a lateral side, and

FIG. 3 illustrates a perspective view of a rotatable grinding tool according to the present disclosure, as seen as from a front side;

FIG. 4 illustrates a perspective view of a rotatable grinding tool according to another embodiment of the present disclosure, as seen as from a front side.

### DETAILED DESCRIPTION OF THE DISCLOSURE

According to the present disclosure, a rotatable grinding tool 1 for clearing a pipe conduit internally is provided. The grinding tool comprises a disc-like body 2, in turn, defining: an intended direction of rotation D, in which the grinding tool 1 is rotatable about a central axis A of the disc-like body 2. The disc-like body 2 further defines, a front side 3 intended to face a surface to be grinded, and a back side 4 opposite to the front side.

The grinding tool 1 further comprising, on the front side 3 of the body 2, a plurality of teeth 5 each extending radially along said front side 3, wherein said teeth 5 are arranged spaced apart from each other. Most suitably, the teeth 6 are axially elevated from the remaining front side 3 of the disc-like body 2. Most suitably, the remaining front side 3 of the disc-like body is substantially planar.

Particularly, the teeth 5 are formed integral with the body 2. That is, the grinding tool 1 is of a monolithic structure. For example, the grinding tool 1 may be formed of a single piece by casting or additive manufacturing. Alternatively, or in addition, the grinding tool may be formed of suitable billet by machining the desired shapes.

An arrangement discussed above has been found to be sufficiently durable efficient for clearing pipe conduits such as sewers, internally. At the same time, a simplified construction of the grinding tool 1 is achieve, as compared to conventional tools having separate tooth inserts attached to the tool.

Preferably, but not necessarily, the teeth 5 are arranged on the front side 3 such that a central portion thereof remains unoccupied, thus enabling coupling of additional tools and/or an actuating cable for rotating the grinding tool 1.

According to an embodiment of the present disclosure, at least the teeth 5 exhibit an increased surface hardness with respect to the base material from which the body 2 is formed.

For example, at least the teeth 5 may be, partially or in whole, tempered or case hardened to achieve an increased surface hardness. Alternatively, or in addition, the whole grinding tool 1 may be subjected to such treatments.

According to an embodiment of the present disclosure, at least one opening 9 extending axially through the disc-like body, between the front side 3 and the back side 4, is provided extending angularly between adjacent teeth 5. Such an opening provides a discharge route for any cutting or debris removed by the teeth 5 of the grinding tool 1. Consequently, any such cuttings or debris no longer remain as an obstacle between the teeth 5 and the surface to be worked on. As a result, more efficient grinding is achieved and less wear of the teeth 5 occur. This further contributes to the longevity of the grinding tool, even without any conventional separate inserts.

Preferably, but not necessarily, such openings 9 are provided between each intermediate angular gap between adjacent teeth 5.

Preferably, but not necessarily, two or more openings 9 may be provided between adjacent teeth 5, such that said two or more openings 9 are radially separated from each other.

Preferably, but not necessarily, such an opening(s) 9 are provided as oblong, angularly extending grooves

Preferably, but not necessarily, the at least one opening 9 occupies at least 30%, preferably at least 40%, and more preferably at least 50%, of an intermediate area delimited between respective adjacent teeth 5. In other words, any openings 9 residing an intermediate area delimited between angularly adjacent teeth 5, suitably occupy the above-mentioned portions of said intermediate area. This further improves efficient removal of cuttings or debris away from the front side 3 of the grinding tool 1.

Preferably, but not necessarily, the at least one opening 9 comprises a length extending in the tangential direction and a width extending in the radial direction, such that the length of the at least one opening 9 is greater than the width thereof. That is, any openings 9 suitably have an oblong shape extending in the direction of rotation. This effectively increases the time per each revolution for a single cutting or debris at a given radial position to travel though the opening 9, as opposed to an opening having a similar area, but shaped differently. Again, efficient removal of cuttings or debris away from the front side 3 of the grinding tool 1 is further improved.

Preferably, but not necessarily, the at least one opening 9 comprises a length extending in the tangential direction, such that the length is at least 60% of a distance between respective adjacent teeth 5 at the radial position of the at least one opening 9. This has been considered to provide a suitable area of the opening 9 for efficient removal or cuttings and debris, while still ensuring sufficient rigidness of the disc-like body 2.

More preferably, the at least one opening 9 comprises a length extending in the tangential direction, such that the length is at least 70% of a distance between respective adjacent teeth 5 at the radial position of the at least one opening 9. Most preferably, the at least one opening 9 comprises a length extending in the tangential direction, such that the length is at least 80% of a distance between respective adjacent teeth 5 at the radial position of the at least one opening 9.

According to an embodiment of the present disclosure, at least one tooth 5 is arranged such that, in the intended rotation direction D, a radially inner end 5a of said tooth 5 is in an angularly leading position with respect to a radially outer 5b end of said tooth 5. In other words, the radially extending teeth 5 may be inclined, such that a radially inner end 5a points towards the direction of rotation.

This results in any debris or cuttings in front of a tooth 5 on its path of rotation to being pushed towards the outer circumference of the grinding tool 1, away from the front side 3 thereof. Again, efficient removal of cuttings or debris away from the front side 3 of the grinding tool 1 is further improved. Simultaneously, the overall length of the tooth 5 can be increased, as compared to non-inclined tooth.

Preferably, but not necessarily, all teeth 5 may be inclined as discussed above.

Preferably, but not necessarily, said at least one tooth 5 is arranged as a curved shape, such as a spiral curve. This further facilitates removal of debris or cuttings towards the outer circumference of the grinding tools 1 and allows increase of the overall length of the tooth 5, as compared to a non-inclined tooth. Suitably all teeth 5 are arranged as curved shapes, as discussed above.

According to an embodiment of the present disclosure, at least one tooth 5 comprises ridge portions 6 and first trough portions 7 arranged radially in an alternating manner, such that the ridge portions 6 are elevated with respect to the first trough portions 7

This allows the ridge portions 7 to primarily engage the surface to be worked. Furthermore, this arrangement allows provides a further discharge route for debris or cuttings in front of said at least tooth 5 on its path of rotation. That is, the first trough portions 7 allows for any cuttings or debris on the leading side of the associated tooth 5 to travel on to the trailing side thereof, thereby further improving the durability and grinding action of the tooth 5.

Suitably, such first trough portions are elevated from the remaining front side 3 of the disc-like body 2.

Suitably all teeth 5 are provided with ridge portions and first trough portions 7, as discussed above.

The ridges 6 and troughs 7 may be provided in various shapes. For example, the ridges 6 and troughs 7 may be formed as having corresponding apexes and bottoms connected by linear and/or curved sections. In another example, the ridges 6 and troughs 7, may be formed a continuous undulating contour of the teeth 5.

Preferably, but not necessarily, said ridge portions 6 comprise respective planar surfaces. That is, the apexes of the ridges and the bottoms of the troughs may be truncarted. Most suitably, such planar portions are parallel with the front side 3 of the disc-like body 2. This allows the cutting forces associated to the respective ridge portion 6 to be distributed along length of the leading side of the planar portion, thereby further improving the durability of the grinding tool 1.

Preferably, but not necessarily, the first trough portions 7 may comprise respective planar surfaces. Most suitably, such planar portions are parallel with the front side 3 of the disc-like body 2. This allows for a for larger discharge route from the leading side of the associated tooth 5 to the trailing side thereof, thereby contributing to improved durability f the grinding tool 1.

Most suitably, such planar surfaces of the first trough portions 7 have a width defined in the radial direction. Moreover, bases of the ridge portions 6, radially delimited by planar surfaces of adjacent first trough portions 7, have a width defined in the radial direction. Particularly, the width of the planar surfaces of the first trough portions 7 are equal to or exceed the width of the bases of the ridge portions 6.

Such an arrangement has been considered to provide an efficient discharge of debris or cuttings while maintaining efficient grinding action of the associated tooth 5.

Preferably, but not necessarily, said at least one tooth 5 further comprises, on each ridge portion 6, a respective second trough portion 8 angularly arranged between a leading edge 6a and a trailing edge 6b of the associated ridge portion 6. Suitably, the remaining part of the ridge portion 6 would then be elevated with respect to the second trough portion 6. Furthermore, such a second trough portion 8 may suitably be arranged elevated with respect to first trough portion 7. Alternatively, such a second trough portion 8 may be arranged on equal elevations as the remaining front side 3 of the disc-like body 2.

Suitably all teeth 5 comprise a second trough portion 8, as discussed above.

It should be noted that the teeth 5 may also be arranged in various alternative layouts.

For example, the plurality of teeth 5 may be arranged equally spaced from each other.

For example, the plurality of teeth 5 may be formed in clusters forming patterns. That is, adjacent teeth 5 in the same cluster are spaced apart for a first distance from each other, while adjacent teeth 5 from separate clusters are spaced apart for a second distance different from the first distance.

For example, the two or more teeth 5 may be arranged angularly and/or tangentially overlapping. That is, two or more teeth 5 may be arranged such that, at a given radial position they tangentially overlap each other, while being radially spaced apart thereat.

For example, the at least two teeth 5 are configured as opposing pairs with respect to the central axis A of the disc-like body 2.

It should also be noted that the present disclosure encompasses any combination of two or more embodiments, or variants thereof, as discussed above.

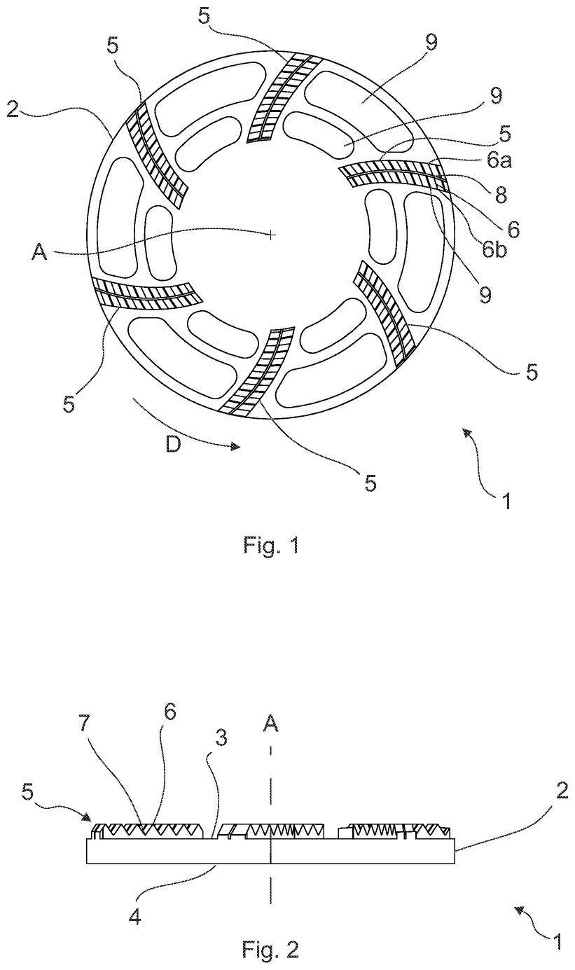

FIG. 1 illustrates a plan view of a rotatable grinding tool 1 according to an embodiment of the present disclosure, as seen as from a front side 3 of the disc-like body 2. A plurality of radially extending teeth 5 are provided on the front side 3, angularly spaced apart from each other. The teeth 5 are equally spaced apart arranged as opposing pairs about the central axis A, about which the disc is rotatable in a predetermined direction of rotation D.

Moreover, the teeth 5 are inclined such that their radially inner ends 5a are arranged in angularly leading positions with respect to their respective radially outer ends 5b. Additionally the teeth 5 are arranged in a curved shape so as to forma spiral curves.

Openings 9 extending axially through the disc-like body 2 are provided between radially adjacent teeth 5. In the illustrated embodiment, two such oblong, tangentially extending separate openings 9, radially spaced apart from each other, are provided in each intermediate area between adjacent teeth 5.

A central portion of the front side 3 of the disc-like body 2 is void of teeth 5 or openings 9

FIG. 2 illustrates a plan view of a rotatable grinding tool 1 of FIG. 1, as, as seen as from a lateral side. Particularly, the teeth 5 are shown forming ridge portions 6 and first trough portions 7 in a radially alternating manner, such that the ridge portion 6 are elevated with respect to the first trough portions 7. Also, it can be seen that the first trough portions are elevated form the remaining front side 3 of the disc-like body 2.

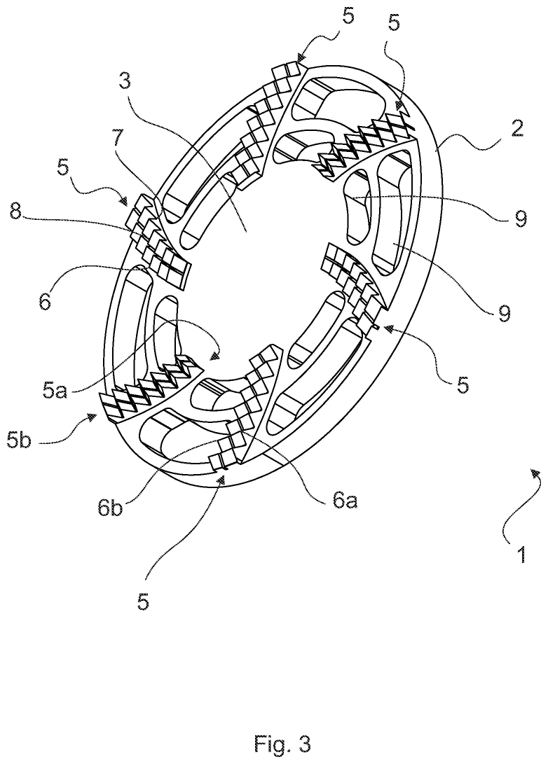

FIG. 3 illustrates a perspective view of the rotatable grinding tool of FIG. 1, as seen as from a front side. Particularly, a second trough portion 8 can be more clearly seen arranged between the leading edges 6a and the trailing edge 6b. Notably, ridge portions 6 are elevated with respect to the second trough portion 8.

In the embodiment of FIG. 3, also the first trough portions 7 are elevated with respect to the second trough portions 8. More precisely, the second trough portions are at an equal elevation with the front side 3 of the disc-like body 2.

It should be noted that other elevations of the second trough portion 8 are also possible, e.g., the second through portions 8 could arranged at an elevation equal or higher with the first trough portions 7.

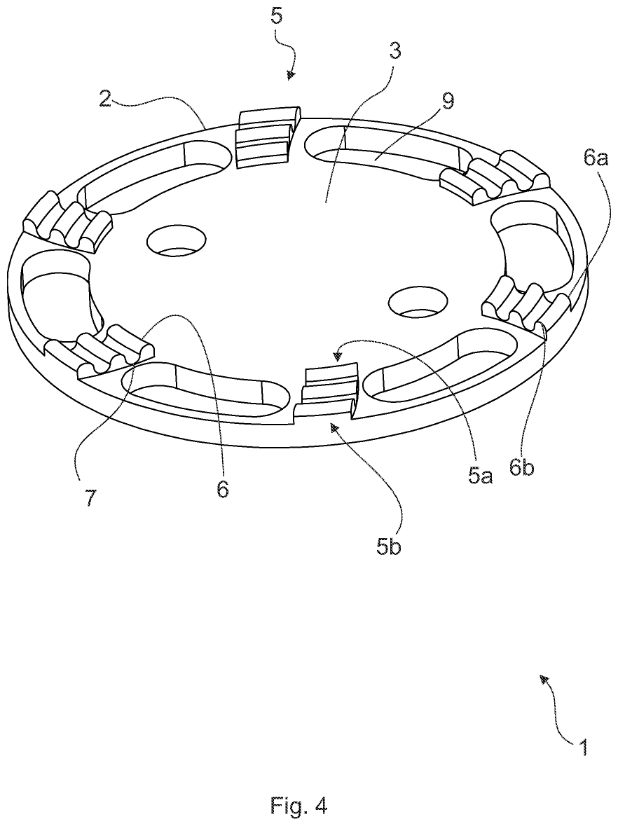

FIG. 4 illustrates a perspective view of a rotatable grinding tool 1 according to another embodiment of the present disclosure, as seen as from a front side 3. A plurality of radially extending teeth 5 are provided on the front side 3, angularly spaced apart from each other. The teeth 5 are equally spaced apart arranged as opposing pairs in a similar manner as the teeth 5 shown inf FIGS. 1-3.

Moreover, the teeth 5 are inclined such that their radially inner ends 5a are arranged in angularly leading positions with respect to their respective radially outer ends 5b. Additionally the teeth 5 are arranged in a curved shape so as to forma spiral curves.

Openings 9 extending axially through the disc-like body 2 are provided between radially adjacent teeth 5. In the embodiment of FIG. 4, a single oblong tangentially extending opening 9, is provided in each intermediate area between adjacent teeth 5.

A central portion of the front side 3 of the disc-like body 2 is void of teeth 5, although two openings for attaching additional components to the grinding tool 1.

Particularly, the teeth 5 are shown forming ridge portions 6 and first trough portions 7 in a radially alternating manner, such that the ridge portion 6 are elevated with respect to the first trough portions 7. In the embodiment of FIG. 4, bottoms of the first trough portions are shown at substantially same elevation with the the remaining front side 3 of the disc-like body 2. Notably, the ridges 6 and troughs 7 in FIG. 4 are provided as an undulating curved contour of the teeth 5.

Although no second trough portions are illustrated in the embodiment of FIG. 4, such second trough portions may equally well be provided in a similar manner as discussed in connection with FIGS. 1-3.

Moreover, although not explicitly illustrated the appended one or more of the ridges 6, first troughs 7 and second troughs 8 may be formed as having a planar surface. That is, instead of having a sharp apex or a continuous curve, a planar section may be provided.

### List of Reference Numerals

1 grinding tool
2 disc-like body
3 front side
4 back side
5 teeth
5a radially inner end
5b radially outer end
6 ridge portion
6a leading point
6b trailing point
7 first trough portions
8 second trough portion
9 opening
D intended direction of rotation
A central axis

1. A rotatable grinding tool for clearing a pipe conduit internally, comprising:
a disc-like body defining:
an intended direction of rotation, in which the grinding tool is rotatable about a central axis of the disc-like body, and
a front side intended to face a surface to be grinded, and a back side opposite to the front side,
wherein the grinding tool further comprises, on the front side of the disk-like body, a plurality of teeth each tooth extending radially along said front side, wherein said plurality of teeth are arranged spaced apart from each other,
wherein the plurality of teeth are formed integral with the disk-like body.

2. The rotatable grinding tool according to claim 1, wherein at least the plurality of teeth exhibit an increased surface hardness with respect to the base material from which the body is formed.

3. The rotatable grinding tool according to claim 1, wherein at least one opening extending axially through the disc-like body, between the front side and the back side, is provided extending angularly between adjacent teeth of the plurality of teeth.

4. The rotatable grinding tool according to claim 3, wherein the at least one opening occupies at least 30%, preferably at least 40%, and more preferably at least 50%, of an intermediate area delimited between respective adjacent teeth.

5. The rotatable grinding tool according to claim 3, wherein the at least one opening comprises a length extending in the tangential direction and a width extending in the radial direction, such that the length of the at least one opening is greater than the width thereof.

6. The rotatable grinding tool according to claim 3, wherein the at least one opening comprises a length extending in the tangential direction, wherein the length is at least 60%, preferably at least 70%, and more preferably at least 80%, of a distance between respective adjacent teeth at the radial position of the at least one opening.

7. The rotatable grinding tool according to claim 1, wherein at least one tooth of the plurality of teeth is arranged such that, in the intended rotation direction, a radially inner end of said tooth is in an angularly leading position with respect to a radially outer end of said tooth.

8. The rotatable grinding tool according to claim 7, wherein said tooth is arranged as a spiral curve.

9. The rotatable grinding tool according to claim 1, wherein at least one tooth of the plurality of teeth comprises ridge portions and first trough portions arranged radially in an alternating manner, such that the ridge portions are elevated with respect to the trough portions.

10. The rotatable grinding tool according to claim 9, wherein said ridge portions comprise respective planar surfaces.

11. The rotatable grinding tool according to claim 10, wherein at least the first trough portions comprise respective planar surfaces.

12. The rotatable grinding tool according to claim 11, wherein:
the planar surfaces of first trough portions have a width defined in the radial direction;
bases of the ridge portions, radially delimited by planar surfaces of adjacent first trough portions, have a width defined in the radial direction, and
the width of the planar surfaces of the first trough portions are equal to or exceed the width of the bases of the ridge portions.

13. The rotatable grinding tool according to claim 9, wherein said tooth further comprises, on each ridge portion, a respective second trough portion angularly arranged between a leading edge and a trailing edge of the associated ridge portion.

14. The rotatable grinding tool according to claim 1, wherein at least two teeth of the plurality of teeth are configured as opposing pairs with respect to the central axis of the disc-like body.
